(19) United States
(12) Patent Application Publication
(10) Pub. No.: US 2009/0173278 A1
(43) Pub. Date: Jul. 9, 2009

(54) Stage apparatus

(76) Inventors: Yasuzou Tanaka, Kanagawa (JP); Junpei Yuyama, Kanagawa (JP); Mitsuru Yahagi, Kanagawa (JP); Hirofumi Minami, Kanagawa (JP)

Correspondence Address: FLOYD B. CAROTHERS;CAROTHERS AND CAROTHERS, 445 FORT PITT BOULEVARD, SUITE 200, PITTSBURGH, PA, 15219, US

(21) Appl. No.: 11/989,670

(22) PCT Filed: Feb. 23, 2007
(86) PCT No.: PCT/JP2007/053354

§ 371 Date: Jan. 29, 2008

(30) Foreign Application Priority Data
Feb. 28, 2006 (JP) 2006-051769

(51) Int. Cl. B05C 13/00

(52) U.S. Cl. 118/500

(57) ABSTRACT

To obtain a stage apparatus that can be divided for land transportation and can properly treat a substrate to be treated, the present invention provides a stage apparatus including a substrate holding plane which holds a substrate to be treated W, a pair of guide frames (13X) oppositely disposed with the substrate holding plane sandwiched therebetween, a gantry (13Y) which extends over the pair of guide frames (13X) and which is movably held by the pair of guide frames (13X), and a substrate treatment unit (14) which is disposed on the gantry (13Y). The guide frames (13X) each are composed of a connected structure of a main frame portion (15A) which forms a moving path (work region R1) of the gantry (13Y) necessary for the substrate treatment unit (14) to perform a substrate treatment, and a sub frame portion (15B) which is connected to one end portion or both end portions in a longitudinal direction of the main frame portion (15A) and which forms a moving path to a non-work position (non-work region R2) of the gantry (13Y).

### TECHNICAL FIELD

The present invention relates to a gantry moving type stage apparatus, in particular, to a stage apparatus used, for example, to coat various types of paste materials such as a sealing material, a liquid crystal material, and a spacer containing resin onto a glass substrate for a liquid crystal panel or perform surface inspection or surface flatness measurement using a camera.

### RELATED ART

So far, for a coating step of coating various types for paste materials such as a sealing material, a liquid crystal material, and a spacer containing resin onto a glass substrate for a liquid crystal panel and a surface inspecting step using a camera, a gantry moving type stage apparatus has been used that moves a discharging nozzle which discharges a paste material or moves a camera in two directions of a plane of a glass substrate (for example, see the following patent document 1).

FIG. 9 is a plan view showing an outlined structure of a conventional stage apparatus of such a type. The shown conventional stage apparatus 1 has a substrate holding table 2 that holds a substrate to be treated on the XY plane, a pair of guide frames 3X that sandwich the substrate holding table 2 and extend in the direction of the X axis, a gantry 3Y that extends over the pair of guide frames, and a substrate treatment unit 4 mounted on the gantry 3Y.

The gantry 3Y is mounted on the guide frames 3X, 3X such that the gantry 3Y can freely move on the upper surface of the guide frames 3X, 3X. The substrate treatment unit 4 is composed of, for example, a discharging nozzle that discharges various types of paste materials such as a sealing material, a liquid crystal material, and a spacer containing resin, or a camera unit that observes the front surface of the substrate. The substrate treatment unit 4 is mounted on the gantry 3Y such that the substrate treatment unit 4 can freely move on the lower surface of the gantry 3Y. The gantry 3Y and the substrate treatment unit 4 are moved along the guide frames 3X and the gantry 3Y, respectively, by a drive source such as a linear motor.

In the conventional stage apparatus 1 having the foregoing structure, the substrate treatment unit 4 is moved above the front surface of the substrate held on the substrate holding table 2. The substrate treatment unit 4, for example, coats the foregoing various types of paste materials onto the substrate or photographs the shape of the front surface of the substrate. By moving the substrate treatment unit 4 in the directions of the X axis and the Y axis, a predetermined treating operation of the substrate treatment unit 4 is intermittently or successively performed for the entire area of the substrate.

In a stage apparatus of this type, in addition to a work region R1 that defines a moving path of the gantry 3Y necessary to treat the substrate, each of the guide frames 3X has a non-work region R2 to which the gantry 3Y escapes from the overhead position of the substrate holding table 2, for example, so as to load and unload the substrate onto and from the substrate holding table 2 or maintain or inspect the substrate treatment unit 4. In other words, the guide frames 3X of the conventional stage apparatus 1 have a length of the work region R1 and the non-work region R2.

Patent Document 1: Patent Number 3701882

Patent Document 2: Japanese Patent Application Laid-Open No. 2006-12911

### DISCLOSURE OF THE INVENTION

### Subject that the Invention is to Solve

In recent years, as the sizes of substrates to be treated have increased, the necessity of increasing the sizes of the stage apparatus that treat them has arisen.

However, as stage apparatus become large, it will become difficult to transport them. When the size of a substrate to be treated is, for example, 3000 mm×2800 mm, the shorter side of the stage apparatus necessarily becomes 3500 mm or more. Thus, the stage apparatus of this size cannot be transported by land according to the current road conditions.

To solve such a problem, a method of dividing a stage apparatus into a plurality of portions is known (for example, see the foregoing patent document 2). However, in the gantry moving type stage apparatus 1 as shown in FIG. 9, if there are joints in the guide frames 3X, 3X on the moving path of the gantry 3Y, when the gantry 3Y passes through the joints, they will cause the gantry 3Y to vibrate and its moving speed to vary. As a result, the substrate treatment unit 4 may not be able to properly treat the substrate.

From the foregoing point of view, the present invention was made. An object of the present invention is to provide a stage apparatus that can be divided for land transportation and that can properly treat a substrate to be treated.

### Means for Solving the Problem

To solve the foregoing problem, a stage apparatus of the present invention includes a substrate holding plane which holds a substrate to be treated, a pair of guide frames oppositely disposed with the substrate holding plane sandwiched therebetween, a gantry which extends over the pair of guide frames and which is movably held by the pair of guide frames, and a substrate treatment unit which is disposed on the gantry. In the stage apparatus, the guide frames each are composed of a connected structure of a main frame portion which forms a moving path of the gantry necessary for the substrate treatment unit to perform a substrate treatment, and a sub frame portion which is connected to one end portion or both end portions in a longitudinal direction of the main frame portion and which forms a moving path to a non-work position of the gantry.

In the stage apparatus having the foregoing structure according to the present invention, since each of the guide frames that guide the gantry that moves is divided into the main frame portion and the sub frame portion, the stage apparatus can be size-reduced such that it can be transported by land. In addition, since the divide positions of the guide frames do not exist on the work region of the gantry, they do not cause the gantry to vibrate and its moving speed to vary, resulting in allowing the stage apparatus to properly treat a substrate to be treated.

In the stage apparatus of the present invention, at least a region that forms a moving path of the gantry necessary for a substrate treatment needs to have a high moving accuracy. Thus, the main frame portion is designed to have a higher moving accuracy than the sub frame portion. As a result, it is not necessary to manufacture the entire guide frames with a high accuracy. Thus, the manufacturing cost of the guide frames and the installation workload can be decreased.

A linear guide which guides a linear movement of the gantry is disposed on each of the guide frames. The linear guide is connected at a position different from the divide position of each of the guide frames. Thus, the moving accuracy of the gantry can be prevented from deteriorating at the divide positions of the guide rails. In addition, since the assembling accuracy of the main frame portion and the sub frame portion can be alleviated, the working efficiency can be improved.

In another stage apparatus of the present invention, a substrate to be treated is mounted and a gantry is moved above the substrate. The stage apparatus includes a first guide portion which includes a portion which guides the gantry when it moves above the substrate, a second guide portion which does not include the portion which guides the gantry when it moves above the substrate, a first frame portion on which the first guide portion is disposed and on which the substrate is mounted, and a second frame portion on which the second guide portion is disposed. In the stage apparatus, the first frame portion and the second frame portion are structured such that they are dividable for transportation.

The first and second guide portions correspond to, for example, linear guides that guide a linear movement of the gantry. When the first and second guide portions are mounted on the first and second frame portions that can be freely divided, the foregoing operation and effect can be obtained. In this case, the first and second guide portions can be mounted on each of the first and second frame portions.

### EFFECT OF THE INVENTION

As described above, according to the present invention, since the guide frames that guide the movement of the gantry each are divided into the main frame portion and the sub frame portion, the stage apparatus can be size-reduced for land transportation. In addition, since the divide positions of the guide frames do not exist on the work region of the gantry, they do not cause the gantry to vibrate and its moving speed to vary, resulting in allowing the stage apparatus to properly treat a substrate to be treated.

### BRIEF DESCRIPTION OF DRAWINGS

FIG. 1 is a schematic diagram showing an outlined structure of a stage apparatus according to an embodiment of the present invention, in which A is an overall perspective view showing an assembled state of the stage apparatus, and B is an overall perspective view showing a pre-assembled state of the stage apparatus.

FIG. 2 is a sectional view seen from the direction of the X axis of the stage apparatus according to the embodiment of the present invention.

FIG. 3 is a sectional perspective view showing an outlined structure of a movable portion of the stage apparatus according to the embodiment of the present invention.

FIG. 4 is a side view showing principal portions of a guide frame of the stage apparatus according to the embodiment of the present invention.

FIG. 5 is a side view showing principal portions of the guide frame of the stage apparatus according to the embodiment of the present invention.

FIG. 6 is a side view showing principal portions of a guide frame of the stage apparatus according to a modification of the embodiment of the present invention.

FIG. 7 is a plan view showing an outline of a stage apparatus according to a modification of the embodiment of the present invention.

FIG. 8 is a perspective view showing an outline of a stage apparatus according to a modification of the embodiment of the present invention.

FIG. 9 is a plan view showing an outlined structure of a conventional stage apparatus.

### DESCRIPTION OF REFERENCE NUMERALS

11 stage apparatus
12 substrate holding table
13X guide frame
13Y gantry
14 substrate treatment unit
15A main frame portion (first frame portion)
15B sub frame portion (second frame portion)
16 pedestal
17 linear guide
17a guide shaft
17a1, 17a2 first and second guide portions
17b guide bearing
18 magnet
19 armature coil
20 movable portion
21 position detection sensor
22 linear scale
22a, 22b first and second scales

### BEST MODES FOR CARRYING OUT THE INVENTION

Next, with reference to the accompanying drawings, an embodiment of the present invention will be described.

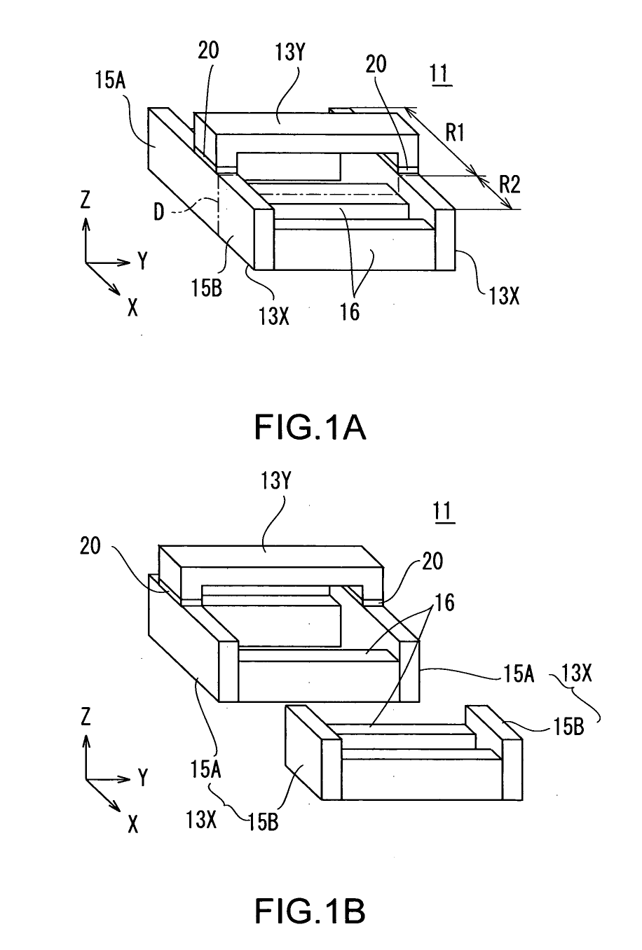

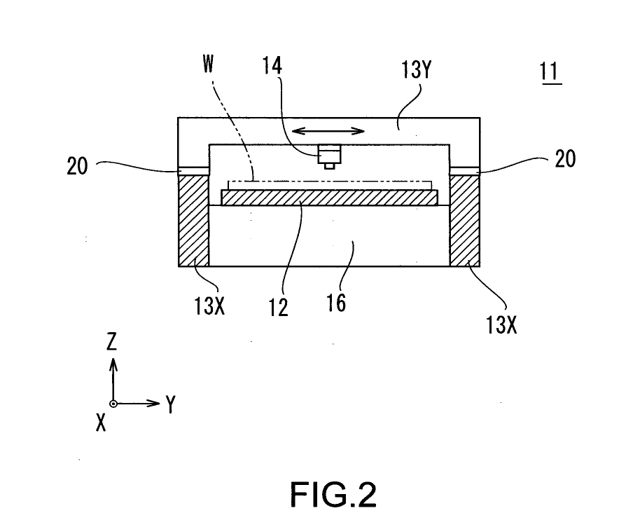

FIG. 1A and FIG. 1B are overall perspective views showing an outlined structure of a stage apparatus 11 according to an embodiment of the present invention, in which A shows an assembled state of the stage apparatus 11 and B shows a pre-assembled state of the stage apparatus 11. FIG. 2 is a sectional view seen from the direction of the X axis of the stage apparatus 11.

The stage apparatus 11 of this embodiment has a substrate holding table 12 that holds a substrate to be treated W such as a glass substrate, a pair of guide frames 13X, 13X that sandwich the substrate holding table 12 and extend in the direction of the X axis, a gantry 13Y that extends over the pair of guide frames 13X, 13X, and a substrate treatment unit 14 that is mounted on the gantry 13Y.

The substrate holding table 12 has a substrate holding plane that holds the substrate W on the XY plane. The substrate holding table 12 is mounted on a pedestal 16 that causes the pair of guide frames 13X, 13X to be oppositely disposed in parallel and spaced with a predetermined distance. The pair of guide frames 13X, 13X are integrally fixed through the pedestal 16. The substrate holding table 20 has a mechanism that holds the substrate W on the substrate holding plane, for example, by vacuum suction. In FIG. 1A and FIG. 1B, the substrate holding table 12 is not shown. A part of the pedestal 16 may compose the substrate holding plane.

The gantry 13Y extends in a direction that intersects the direction in which the guide frames 13X, 13X extend (the direction of the X axis). Specifically, in this embodiment, the gantry 13Y extends in a direction (the direction of the Y axis) perpendicular to the direction in which the guide frames 13X, 13X extend. Both leg portions of the gantry 13Y are supported by the guide frames 13X, 13X such that the leg portions are freely movable on the upper surface of the guide frames 13X, 13X through movable portions 20.

The substrate treatment unit 14 is composed of, for example, a discharging nozzle that discharges various types of paste materials such as a sealing material, a liquid crystal material, and a spacer containing resin to the front surface of the substrate W held on the substrate holding table 12, or a camera unit that observes the front surface of the substrate W. The substrate treatment unit 14 is held by the gantry 13Y such that the substrate treatment unit 14 is freely movable on the lower surface of the gantry 13Y.

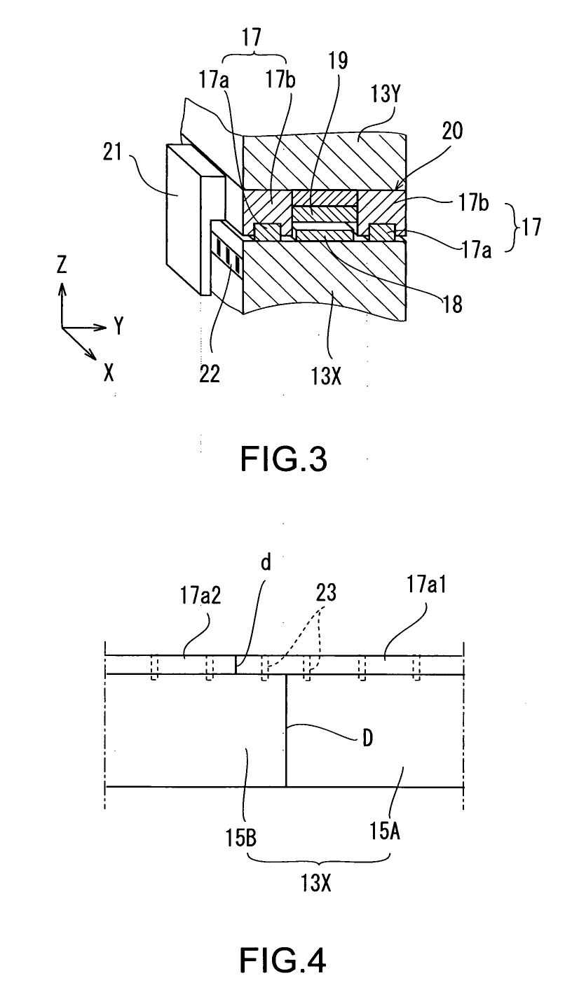

The gantry 13Y and the substrate treatment unit 14 are moved along the guide frames 13X, 13X and the gantry 13Y, respectively, by a linear motor as a drive source. FIG. 3 shows an example of a structure of the movable portion 20 disposed between the guide frames 13X, 13X and the gantry 13Y. The structure that follows is also applied between the gantry 13Y and the substrate treatment unit 14.

As shown in FIG. 3, the movable portion 20 has a linear guide 17, a magnet 18, and an armature coil 19. The linear guide 17 is composed of a pair of guide shafts 17a, 17a mounted on the upper surfaces of the guide frames 13X and a pair of guide bearings 17b, 17b mounted on the lower surfaces of the leg portions of the gantry 13Y. The magnet 18 is linearly mounted on the upper surfaces of the guide frames 13X between the pair of guide shafts 17a, 17a. The armature coil 19 is mounted on the lower surfaces of the leg portions of the gantry 13Y such that the armature coil 19 faces the magnet 18 with a space. The magnet 18 and the armature coil 19 compose a linear motor.

Also mounted on the movable portion 20 is a position detection sensor 21 that detects a relative position of the gantry 13Y with respect to the guide frames 13X. By optically detecting a linear scale 22 mounted on a side surface of the guide frame 13X, the position detection sensor 21 detects the position of the gantry 13Y.

The stage apparatus 11 has a control section (not shown) that controls the movements of the gantry 13Y and the substrate treatment unit 14 according to an output of the position detection sensor having the structure described above. The description of the control section will be omitted.

By horizontally moving the gantry 13Y in the direction of the X axis with respect to the guide frames 13X, 13X and horizontally moving the substrate treatment unit 14 in the direction of the Y axis with respect to the gantry 13Y, the substrate treatment unit 14 can be positioned in two directions of the XY plane while facing the entire front surface of the substrate W held by the substrate holding table 12. As a result, the stage apparatus 11 is structured as an XY stage on which the substrate treatment unit 14 successively or intermittently performs a predetermined substrate treating operation (in this example, a coating treatment for a sealing material, a liquid crystal material, and a spacer containing resin, or a surface inspection) on the substrate W.

In the stage apparatus 11 of this embodiment, each of the guide frames 13X, 13X is composed as a connected structure of a main frame portion (first frame portion) 15A and a sub frame portion (second frame portion) 15B obtained by dividing the guide frames 13X, 13X in the direction in which they extend. Thus, as shown in FIG. 1B, in the stage apparatus 11, each of the guide frames 13X, 13X can be divided between the main frame portion 15A and the sub frame portion 15B. In this case, the substrate W is placed on the main frame portion 15A side.

Since the guide frames 13X, 13X are dividable in the direction in which they extend, the stage apparatus 11 can be transported in such a manner that it is divided as two portions in the direction of the X axis.

Even if the length in the direction of the X axis of the stage apparatus 11 is 5500 mm or more and the width in the direction of the Y axis thereof is 4500 mm or more, when the stage apparatus 11 is divided into two portions in the direction of the X axis, the length in the direction of the X axis of each of the divided portions can be limited to 3500 mm or less. Thus, since the restriction based on the road conditions and the like is cleared, the stage apparatus 11 can be transported by land.

In this embodiment, the divide position of each of the guide frames 13X, 13X, namely a boundary D between the main frame portion 15A and the sub frame portion 15B, is set at a boundary position of a work region R1 that defines a moving path of the gantry 13Y necessary for a substrate treatment by the substrate treatment unit 14 and a non-work region R2 to which the gantry 13Y escapes from the overhead position of the substrate holding table 12.

The non-work region R2 defines a non-work position to which the gantry 13Y escapes when the substrate W is loaded onto and unloaded from the substrate holding table 12 or when the substrate treatment unit 14 is, for example, maintained or inspected.

Thus, the main frame portion 15A forms a moving path of the gantry 13Y necessary for the substrate treatment unit 14 to perform a substrate treatment. On the other hand, the sub frame portion 15B is connected to one end side of the main frame portion 15A in the longitudinal direction and forms a moving path of the gantry 13Y to the non-work position.

As described above, since the boundary D between the main frame portion 15A and the sub frame portion 15B that compose each of the guide frames 13X, 13X is disposed at the boundary of the work region R1 and the non-work region R2 of the gantry 13Y on each of the guide frames 13X, 13X, the following effects can be obtained.

First, in general, in the gantry moving type stage apparatus, when a substrate treatment is performed, the gantry needs to be accurately moved. However, according to this embodiment, only the main frame portion 15A that defines the work region R1 of the gantry 13Y needs to be designed to have a predetermined precise moving accuracy. Thus, the sub frame portion 15B does not need to have a precise moving accuracy as compared with the main frame portion 15A. As a result, the total manufacturing cost of the stage apparatus 11 can be decreased.

The moving accuracy of the gantry 13Y depends on the rigidity and flatness of the moving surface of the gantry 13Y, a uniform speed movement of the gantry 13Y, and so forth. To satisfy these conditions, the guide frames are made of a stone material such as granite or marble, or a material that has a high machining accuracy and that is relatively expensive, such as a hard ceramic made of SiC. In this embodiment, only the main frame portion 15A has to be made of such a material. In contrast, the sub frame portion 15B can be made of a material that has a moderate moving accuracy and that is relatively inexpensive.

Second, if there are joints (boundary D) of the guide frames 13X, 13X in the work region R1 of the gantry 13Y, when the gantry 13Y passes through the work region R1, they cause the gantry 13Y to vibrate and its moving speed to vary. However, since there are no joints, when the gantry 13Y passes through the work region R1, the gantry 13Y does not vibrate and its moving speed does not vary. As a result, the substrate treatment unit 14 can properly treat the substrate to be treated W.

Third, since the divide position (boundary D) of each of the guide frames 13X, 13X is set at the boundary of the work region R1 and the non-work region R2 of the gantry 13Y, the assembling efficiency of the stage apparatus 11 can be improved.

In other words, when the divide position of each of the guide frames 13X, 13X is in the work region R1 of the gantry 13Y, the guide frames need to be accurately connected so as to accurately move the gantry 13Y. As a result, the installation workload is increased. In contrast, according to this embodiment, such a problem can be solved. Thus, the installation workload of the guide frames 13X, 13X can be decreased.

In addition, as shown in FIG. 1B, since the stage apparatus can be transported in the state where the gantry 13Y is mounted to the main frame portion 15A, the assembling work of the movable portion 20 can be omitted at site. Thus, the installation efficiency of the stage apparatus 11 can be improved. In addition, the stage apparatus 11 can be shipped in the state where the gantry 13Y is assembled to the main frame portion 15A with a high accuracy.

Like the guide frames 13X, 13X, the linear guide 17 that guides the movement of the gantry 13Y on the guide frames 13X, 13X is dividably structured. In this embodiment, the linear guide 17 is connected at a position different from the divide position of each of the guide frames 13X, 13X.

FIG. 4 is a side view showing the divide position of each of the guide frames 13X, 13X. Each of the guide frames 13X, 13X is composed of the main frame portion 15A and the sub frame portion 15B that are connected. Respectively mounted on the upper surfaces of the frame portions 15A and 15B are guide shafts (first and second guide portions) 17a1 and 17a2 of the linear guide 17. The first guide portion 17a1 is structured such that when the gantry 13Y moves above the substrate W, the first guide portion 17a1 includes a portion for which the first guide portion 17a1 guides the gantry 13Y (work region R1). In contrast, the second guide portion 17a2 is structured such that when the gantry 13Y moves above the substrate W, the second guide portion 17a2 does not include a portion for which the second guide portion 17a2 guides the gantry 13Y.

The first and second guide portions 17a1 and 17a2 are disposed on the same axis. They are connected by a joint d at a position different from the divide position (boundary D) of each of the guide frames 13X. In other words, as shown in FIG. 4, the first guide portion 17a1 extends more on the sub frame portion 15B side than the main frame portion 15A side. The extended portion of the first guide portion 17a1 is secured on the sub frame portion 15B. The second guide portion 17a2 is connected to the end of the extended portion of the first guide portion 17a1 on the sub frame portion 15B so as to continuously form the guide shaft 17a.

As shown in FIG. 4, since the joint d of the first and second guide portions 17a1 and 17a2 is different from the divide position D of each of the guide frames 13X, the divide position D of each of the guide frames 13X can be covered by the first guide portion 17a1. As a result, a gap that is generated when the main frame portion 15A and the sub frame portion 15B are assembled can be absorbed by the first guide portion 17a1. Thus, when the gantry 13Y passes through the divide position D, the gantry 13Y can be effectively prevented from vibrating. In addition, since it is not necessary to assemble the main frame portion 15A and the sub frame portion 15B with a strict assembling accuracy, the installation efficiency of the guide frames 13X, 13X can be further improved.

After the main frame portion 15A and the sub frame portion 15B are assembled as each of the guide frames 13X, the first and second guide portions 17a1 and 17a2 are secured on each of the guide frames 13X with screw members 23.

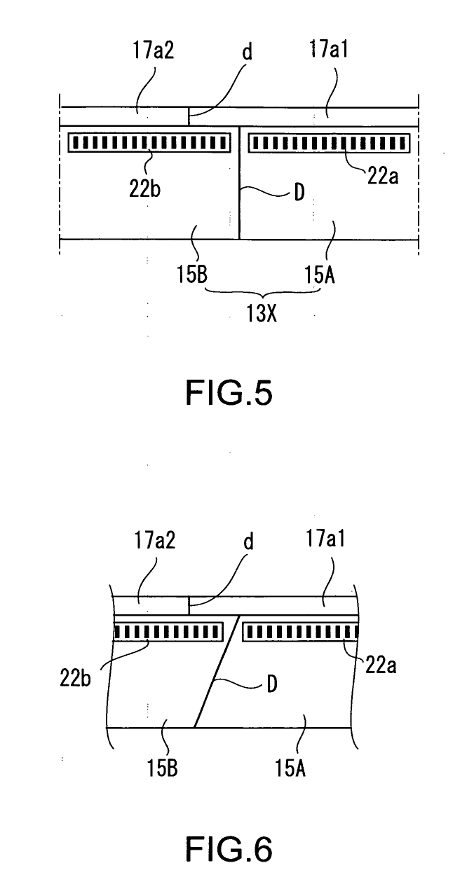

In addition, the linear scale 22 necessary to detect the position of the gantry 13Y is divided and mounted on at least one of the guide frames 13X so as to improve the installation efficiency of the stage apparatus 11. In other words, as schematically shown in FIG. 5, the linear scale 22 is divided into a first scale 22a mounted on the main frame portion 15A and a second scale 22b mounted on the sub frame portion 15B. Unlike with a long linear scale that is not divided, this structure of the linear scale 22 prevents the accuracy of the linear scale 22 from deteriorating by thermal expansion. As a result, the moving accuracy of the gantry 13Y can be improved.

In this case, at least two linear scale detecting sections that detect the first scale 22a and the second scale 22b are disposed in line in the moving direction of the gantry 13Y. The linear scale detecting sections may be two or more position detection sensors 21 that have been described above. Instead, in one position detection sensor 21, two detecting sections (elements) may be mounted. Since these detecting sections are spaced with a distance larger than the mounting interval of the scales 22a and 22b, detection can be performed across the scales 22a and 22b.

In the foregoing structure, when the gantry 13Y passes through the connection portion of the main frame portion 15A and the sub frame portion 15B, one of the linear scale detecting sections detects the first scale 22a and the other detects the second scale 22b so as to compensate the position at the connection portion of the frames. Specifically, when one detecting section passes through the connection portion of the scale, the position of this detecting section is calculated on the basis of an output of the other detecting section and the mounting interval of these detecting sections. Thus, even when the scales 22a and 22b are divided, the position of the gantry 13Y can be accurately detected. In addition, since it is not necessary to mount the scales 22a and 22b with an accurate mounting interval, the working efficiency can be improved.

The number of linear scale detecting sections is not limited to two. Instead, the number of linear scale detecting sections may be increased. The divide position of the linear scale is not limited to the foregoing connection position of each of the frame portions.

An embodiment of the present invention has been described. It should be noted that the present invention is not limited to such an embodiment. Instead, various modifications may be made on the basis of the spirit of the present invention.

In the foregoing embodiment, connection surfaces of the main frame portion 15A and the sub frame portion 15B that compose each of the guide frames 13X are perpendicular to the moving direction of the gantry 13Y. Of course, the present invention is not limited to such an example. FIG. 6 shows an example in which connection surfaces of the main frame portion 15A and the sub frame portion 15B have an angle with respect to the moving direction of the gantry 13Y. In this structure, the accuracy of the height of the upper surface of the frame at the boundary D of the main frame portion 15A and the sub frame portion 15B can be easily obtained. As a result, the installation efficiency of the guide frames 13X can be improved.

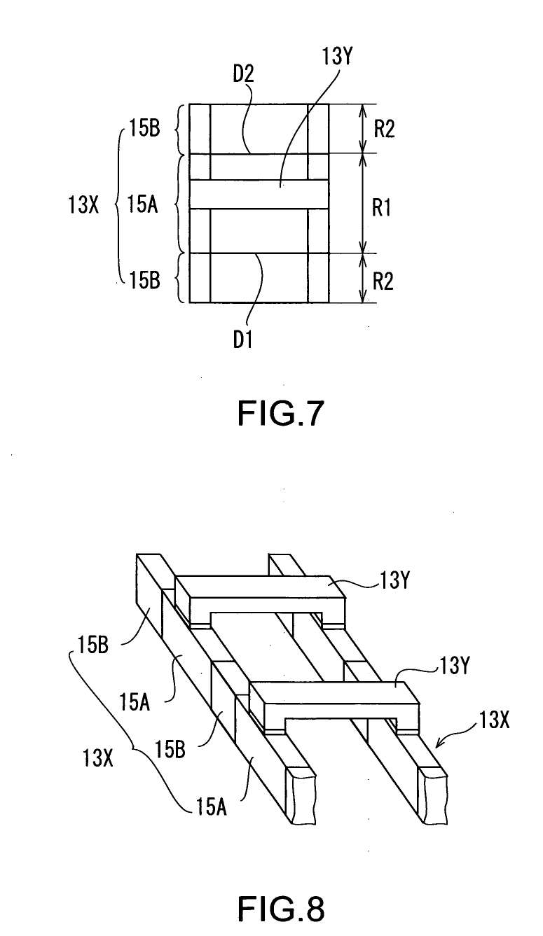

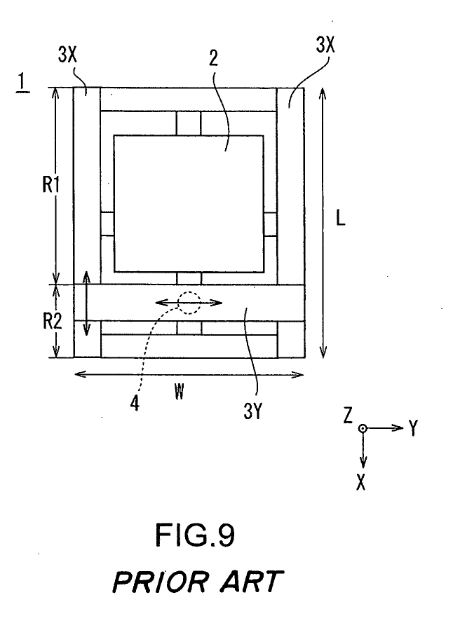

In the foregoing embodiment, each of the guide frames 13X, 13X of the stage apparatus 11 is divided into two portions. Instead, as schematically shown in FIG. 7, each of the guide frames 13X, 13X may be divided into three portions. In this example, the sub frame portions 15B are connected to each end of the main frame portion 15A.

Instead, each of the guide frames 13X, 13X may be further divided into four or more portions. FIG. 8 shows a stage apparatus of which the main frame portions 15A and the sub frame portions 15B are alternately connected. In this structure, a plurality of substrates to be treated W can be treated in parallel by the same stage apparatus.

1-9. (canceled)

10. A stage apparatus for treating a substrate to be treated or inspecting the substrate, comprising:
a substitute holding plane which holds the substrate;
a substitute treatment unit which treats or inspects the substrate supported by the substrate holding plane;
a gantry which supports the substrate treatment unit and is movable above the substrate supported by the substrate holding plane;
a pair of guide portions opposed to each other with the substrate holding plane sandwiched therebetween, each of which includes a first guide portion which forms a moving path of a work region of the gantry necessary for the substrate treatment unit to treat the substrate, and a second guide portion connected to be separable from the first guide portion in a direction in which the first guide portion extends and which forms a moving path of a non-work region of the gantry;
a main frame which supports the first guide portion; and
A sub frame which supports the second guide portion and is separable from the main frame.

11. The stage apparatus according to claim 10, wherein the main frame is designed to have a higher moving accuracy of the gantry than the sub frame.

12. The stage apparatus according to claim 10, wherein the first guide portion and the second guide portion respectively include linear guides for guiding a linear movement of the gantry, and wherein the linear guides are coupled at a position different from a divide position between the main frame and the sub frame.

13. The stage apparatus according to claim 10, wherein the substrate treatment unit is movably supported by the gantry in a direction in which the gantry extends.

14. A stage apparatus for treating a substrate to be treated or inspecting the substrate, comprising:
a first frame portion on which the substrate is mounted;
a second frame portion structured to be capable of being separated from the first frame portion for transportation;
a gantry which moves above the substrate;
a first guide portion disposed on the first frame portion, which includes a portion that guides the gantry when the gantry moves above the substrate integrally in a longitudinal direction; and
a second guide portion disposed on the second frame portion and does not include the portion that guides the gantry when the gantry moves above the substrate.

15. The stage apparatus according to claim 14, wherein the first frame portion exhibits a higher moving accuracy of the gantry than the second frame portion.

16. The stage apparatus according to claim 14, wherein the first guide portion has a part protruding farther than the first frame portion, the protruding part of the first guide portion is secured to the second frame portion, and the first guide portion and the second guide portion constitute a successive guide portion.

17. The stage apparatus according to claim 14, wherein connection surfaces of the first frame portion and the second frame portion have an angle with respect to a moving direction of the gantry.

18. The stage apparatus according to claim 14, further comprising;
a first linear scale disposed in the first frame portion;
a second linear scale disposed in the second frame portion; and
at least two linear scale detecting sections disposed on the gantry, for detecting a position of the gantry with the first linear scale and the second linear scale when the gantry passes a connection portion of the first frame portion and the second frame portion, to thereby compensate the position detection at the connection portion.
